(19) United States
(12) Patent Application Publication
(10) Pub. No.: US 2008/0096022 A1
(43) Pub. Date: Apr. 24, 2008

(54) Electromagnetic Wave Shielding Sheet, And Method For Producing The Same

(75) Inventors: Nobuo Naito, Tokyo-To (JP); Fumihiro Arakawa, Tokyo-To (JP); Tadahiro Masaki, Tokyo-To (JP)

Correspondence Address: OLIFF & BERRIDGE, PLC, P.O. BOX 320850, ALEXANDRIA, VA, 22320-4850, US

(73) Assignee: Dai Nippon Printing Co., Ltd., Tokyo (JP)

(21) Appl. No.: 10/585,404

(22) PCT Filed: Jan. 12, 2005
(86) PCT No.: PCT/JP05/00227

§ 371 Date: Aug. 25, 2006

(30) Foreign Application Priority Data
Jan. 13, 2004 (JP) 2004-004997

(51) Int. Cl. B32B 15/04

(52) U.S. Cl. 428/409; 216/39

(57) ABSTRACT

Disclosed is an electromagnetic shielding sheet comprising a transparent base (11) and a mesh metal layer (21) arranged on one side of the transparent base (11) via an adhesive layer (13). The metal layer (21) has a mesh portion (103) wherein many opening portions (105) are surrounded by a line portion (107), and a frame portion (101) arranged around the mesh portion (103). The opening portions (105) are filled with a transparent ionizing radiation-curing resin layer (31).

### FIELD OF THE INVENTION

The present invention relates to an electromagnetic wave shielding sheet that shields EMI (electromagnetic (wave) interference) which is caused by electromagnetic waves emitted from displays such as cathode ray tubes (hereinafter also referred to as CRTs) and plasma display panels (hereinafter also referred to as PDPs). More specifically, the present invention relates to a method for producing an electromagnetic wave shielding sheet that is superior in transparency, by laminating a metal mesh foil to a transparent substrate via an adhesive layer and filling surface irregularities of the adhesive layer exposed at openings of the metal mesh foil.

In this Specification, “ratio”, “part”, “%”, and the like that indicate proportions are on a weight basis unless otherwise specified. The symbol “/” denotes that layers described before and after this symbol are integrally laminated. “NIR”, “UV”, “PET”, and “adhesive force” are abbreviations, synonyms, functional expressions, common designations, or terms used in the art, which designate “near infrared rays”, “ultraviolet light”, “polyethylene terephthalate”, and “expression including adhesive force, sticking force and sealing force” respectively. In addition, “ionizing radiation curing resin” means resin before curing, and “ionizing radiation cured resin” means resin that has been cured.

### BACKGROUND ART

### Background of Technique

Electromagnetic waves which electromagnetic equipment generates adversely affect other electromagnetic equipment, and are said to have adverse influences also on the human body and animals. Thus, a variety of measures have already been taken to shield such electromagnetic waves.

Particularly, PDPs that have recently come to be used generate electromagnetic waves whose frequencies are 30 to 130 MHz. Such electromagnetic waves can adversely affect computers or computerized apparatuses placed near the PDPS. It is therefore desirable to shield, as much as possible, electromagnetic waves emitted from PDPs.

If the electromagnetic wave shielding sheet has exposed roughened surfaces, or contains fine air bubbles that have been incorporated in its constitution, it irregularly reflects light to increase haze. Such an electromagnetic wave shielding sheet may lower image contrast when mounted on displays such as PDPs. Thus, the electromagnetic wave shielding sheet is also required to have such transparency that they do not impair display visibility.

In addition, in order to further enhance the property of shielding electromagnetic waves, the electromagnetic wave shielding sheet is required to have, in a frame part of its metal mesh layer, an exposed surface for grounding.

### Prior Art

Conventionally, as a measure for obtaining satisfactory transparency, an electromagnetic wave shielding sheet, produced by forming a transparent indium tin oxide (abbreviation: ITO) film on a transparent film, has been proposed and known (see Japanese Patent Laid-Open Publications No. 278800/1989 and No. 323101/1993, for example). However, such an electromagnetic wave shielding sheet is disadvantageous in that it is insufficient in electrical conductivity and is lacking in the property of shielding electromagnetic waves.

There has recently been proposed an electromagnetic wave shielding sheet that is produced by laminating, to a transparent film, a metal mesh obtained by etching a metal foil (see Japanese Patent Laid-Open Publications No. 119675/1999 and No. 210988/2001, for example). Such a metal mesh is usually produced by laminating a metal foil and a transparent substrate with a layer of an adhesive (adhesive layer) and by photolithographically making the metal foil into a mesh. Such an electromagnetic wave shielding sheet has the ability to shield electromagnetic waves high enough to shield strong electromagnetic waves emitted from PDPs. However, in such an electromagnetic wave shielding sheet, the surface irregularities of the metal foil are transferred to the surface of the adhesive layer exposed at the openings of the metal mesh to roughen the surface. Moreover, fine air bubbles tend to be incorporated in the adhesive layer in the course of applying adhesive agents on the metal mesh surface and laminating the metal mesh foil and the other member via the adhesive layer. The air bubbles incorporated in such a way decrease the adhesive force of the adhesive layer, and irregularly reflect light to lower the contrast of an image displayed on a display such as a PDP, viewed from the transparent substrate side.

### SUMMARY OF THE INVENTION

Based on a different thought-pattern, the inventor has created a new invention of an electromagnetic wave shielding sheet and a method for producing the same, wherein the electromagnetic wave shielding sheet has transparency enough not to impair the visibility of an image displayed on a display and has a metal frame part with an exposed surface for grounding, while it is allowed to have some surface irregularities.

That is, the present invention was accomplished in order to solve the above-described problems, and an object of the present invention is to provide an electromagnetic wave shielding sheet and a method for producing the same, wherein the electromagnetic wave shielding sheet has transparency enough not to impair the visibility of an image displayed on a display and has a metal frame part with an exposed surface for grounding.

In order to fulfill the above-described objects, the present invention provides an electromagnetic wave shielding sheet comprising: a transparent substrate; and a metal mesh layer laminated to a surface of the transparent substrate by an adhesive layer; wherein the metal mesh layer has a mesh part and a frame part around the mash part, the mesh part having a plurality of openings and a plurality of line parts defining the plurality of openings; a metal surface is exposed at the frame part on a side opposite to the adhesive layer; and the plurality of openings is filled with a transparent ionizing radiation cured resin.

According to the present invention, an electromagnetic wave shielding sheet having transparency enough not to impair the visibility of an image displayed on a display, having a frame part of a metal layer with an exposed surface for grounding, and having superior ability to shield electromagnetic waves can be provided.

Preferably, surface roughness of the surface of the frame part on the side opposite to the adhesive layer is 0.5 to 1.5 μm as a mean surface roughness value of 10 measurements, obtained in accordance with JIS-B0601 (1994 version).

In the case, it is easy to surely and stably manufacture an electromagnetic wave shielding sheet wherein openings of a mesh part are covered with a transparent ionizing radiation cured resin layer and wherein a metal layer is exposed at a frame part. In addition, it is possible to obtain satisfactory performance of preventing reflection of extraneous light.

In addition, the present invention is a method for producing an electromagnetic wave shielding sheet having any of the above features, comprising the steps of: (1) laminating a metal layer to a surface of a transparent substrate by a transparent adhesive layer, thereby obtaining a laminate; (2) providing a mesh-patterned resist layer on the metal layer face of the laminate, etching the metal layer to remove portions thereof that are not covered with the resist layer, and removing the resist layer, thereby forming in the metal layer a mesh part and a frame part around the mesh part; (3) applying liquid and transparent ionizing radiation curing resin onto the mesh part and the frame part, laminating a pattern-transfer film onto the ionizing radiation curing resin, and applying ionizing radiation to the ionizing radiation curing resin on a side of the pattern-transfer film, thereby curing the ionizing radiation curing resin; and (4) removing the pattern-transfer film, and removing the ionizing radiation cured resin at least on the frame part, with leaving the ionizing radiation cured resin in the openings of the mesh part.

According to the present invention, it is possible to easily manufacture an electromagnetic wave shielding sheet having transparency enough not to impair the visibility of an image displayed on a display, having superior ability to shield electromagnetic waves, and having a surely exposed metal layer at a frame part, by means of the existing facilities and techniques.

For example, the ionizing radiation is ultraviolet light, and the pattern-transfer film is permeable to ultraviolet light. If ultraviolet light is selected, it is possible to efficiently, simply and inexpensively a desired electromagnetic wave shielding sheet, because irradiation equipment of ultraviolet light is inexpensive, prevails technically, and is easy to handle.

In addition, preferably, an interlayer adhesive force between the adhesive layer and the ionizing radiation cured resin layer, an interlayer adhesive force between the ionizing radiation cured resin layer and the pattern-transfer film, and an interlayer adhesive force between the ionizing radiation cured resin layer and the metal layer are smaller in that order. In the case, it is possible to more surely manufacture an electromagnetic wave shielding sheet having transparency enough not to impair the visibility of an image displayed on a display, having superior ability to shield electromagnetic waves, and having a surely exposed metal layer at a frame part.

### BRIEF DESCRIPTION OF THE DRAWINGS

FIG. 1 is a plan view of an electromagnetic wave shielding sheet according to an embodiment of the present invention;

FIG. 2 is a perspective view showing the mesh part of FIG. 1;

FIG. 3 is a sectional view showing a main part of the electromagnetic wave shielding sheet according to the embodiment of the present invention;

FIG. 4 is a sectional view showing a modified metal layer;

FIG. 5 is a schematic sectional view showing a main part of a producing system used for a method of producing an electromagnetic wave shielding sheet according to an embodiment of the present invention;

FIG. 6 are sectional views of a main part of an electromagnetic wave shielding sheet for explanation of a peeling state during a method for producing an electromagnetic wave shielding sheet according to an embodiment of the present invention; and

FIGS. 7(A) and 7(B) are sectional views of a main part of an electromagnetic wave shielding sheet for explanation of a peeling state during a method for producing an electromagnetic wave shielding sheet as a comparison.

### BEST MODE FOR CARRYING OUT THE INVENTION

Embodiments of the present invention will be described hereinafter with reference to the accompanying drawings.

### (Basic Method)

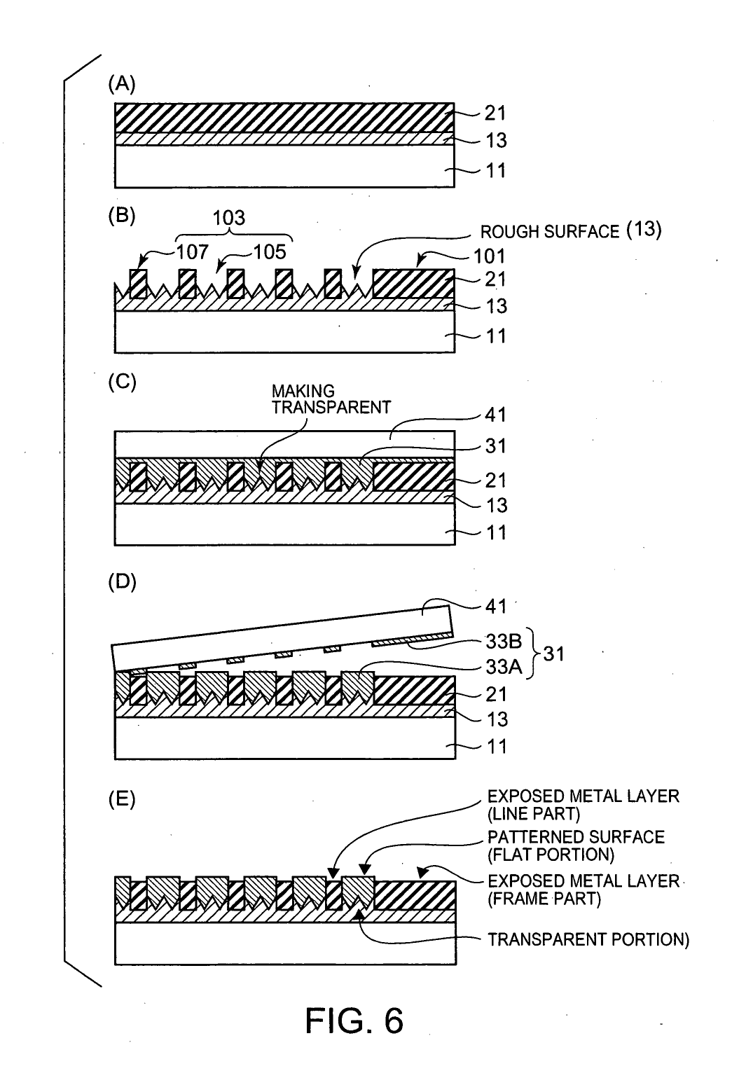

As shown in FIG. 6, a method for producing an electromagnetic wave shielding sheet according to the present invention consists of the steps of:

(1) laminating a metal layer 21 to a surface of a transparent substrate 11 by a transparent adhesive layer 13, thereby obtaining a laminate (FIG. 6(A)),

(2) providing a mesh-patterned resist layer on the metal layer face of the laminate, etching the metal layer to remove portions thereof that are not covered with the resist layer, and removing the resist layer, thereby forming in the metal layer 21 a mesh part 103 and a frame part 101 around the mesh part (FIG. 6(B)),

(3) applying liquid and transparent ionizing radiation curing resin 31 onto the mesh part and the frame part, laminating a pattern-transfer film 41 onto the ionizing radiation curing resin, and applying ionizing radiation to the ionizing radiation curing resin on a side of the pattern-transfer film, thereby curing the ionizing radiation curing resin (FIG. 6(C)), and

(4) removing the pattern-transfer film, and removing the ionizing radiation cured resin 33B at least on the frame part 101, with leaving the ionizing radiation cured resin 33A in the openings 105 of the mesh part (FIG. 6(D)).

Herein, as shown in FIG. 6(D), in order to surely peel off the ionizing radiation cured resin 33B from the metal layer 21 only on the frame part 101 and to peel off the pattern-transfer film while the adhesive layer 13 and the ionizing radiation cured resin 33A are surely bonded to each other at the openings 105 of the mesh part, it is preferable that the ionizing radiation is ultraviolet light and that the pattern-transfer film is permeable to ultraviolet light. Specifically, it is preferable that the pattern-transfer film is a polyethylene terephthalate film whose surface is substantially smooth or matted and whose surface wettability is 35 to 45 mN/m. In the case, the following relationship can be obtained regarding the interlayer adhesive forces: the interlayer adhesive force between the adhesive layer and the ionizing radiation cured resin layer>the interlayer adhesive force between the ionizing radiation cured resin layer and the pattern-transfer film>the interlayer adhesive force between the ionizing radiation cured resin layer and the metal layer.

In addition, regarding the metal layer, in order to completely and stably peel off the ultraviolet cured resin layer from the metal layer so as to expose a surface of the metal layer, it is preferable that a mean surface roughness value of 10 measurements, Rz, of the metal layer is 1.5 μm or less. In addition, it is preferable that the value Rz is 0.5 μm or more in view of preventing reflection of extraneous light at the surface of the metal layer.

### (Basic Structure)

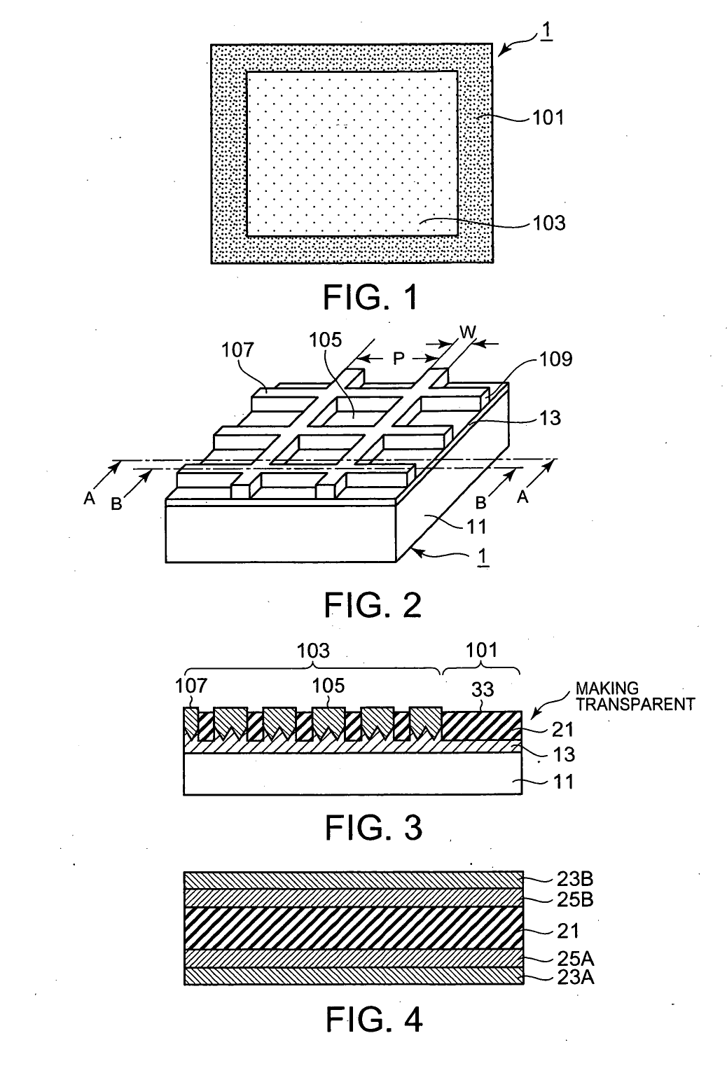

As shown in FIGS. 1 and 2, the electromagnetic wave shielding sheet 1 according to the present invention comprises, at least, the mesh part 103 and the frame part 101 provided around the mesh part 103. As shown in the sectional view of FIG. 3, the metal mesh layer 21 is laminated to one surface of the transparent substrate 11 via the transparent adhesive layer 13. Portions of the adhesive layer 13 exposed at the openings 105 of the metal mesh layer 21 are filled and covered with the ionizing radiation cured resin layer 33. On the other hand, a metal surface is exposed at the frame part 101 of the metal layer. For the purpose of grounding, it is sufficient that the metal layer has an exposed surface at the frame part 101. The surfaces of the line parts 107 of the mesh part may be exposed or covered with the ionizing radiation cured resin layer. Shortly speaking, it is sufficient that concave portions at the openings of the mesh part are filled with the ionizing radiation cured resin layer to be flat as a whole and that the roughed surface of the adhesive layer is optically eliminated by the filling of the ionizing radiation cured resin layer.

In the embodiment of FIG. 3, a metal surface is exposed at the line parts 107. In addition, in FIG. 2, the ionizing radiation cured resin layer 33 is omitted for facility of understanding.

In addition, in order to surely and stably manufacture an electromagnetic wave shielding sheet wherein the adhesive layer at the openings of the mesh part is covered by the ionizing radiation cured resin layer and wherein the metal layer is exposed at the frame part, it is preferable that the surface roughness of the surface of the frame part on the side opposite to the adhesive layer is 0.5 to 1.5 μm as a mean surface roughness value of 10 measurements, Rz.

In addition, preferably, it is possible to manufacture an electromagnetic wave shielding sheet of the present invention, in accordance with a method for producing an electromagnetic wave shielding sheet defined by claim 3. In addition, the surface of the ionizing radiation cured resin layer 33 that has been filled and cured is substantially smooth or matted.

Hereinafter, respective steps of the method for producing an electromagnetic wave shielding sheet are explained, along with materials to be used therein.

### (First Step)

This step is a step of laminating the metal layer to the transparent substrate via the adhesive layer, thereby forming a laminate.

### (Metal Layer)

Metals having electrical conductivity good enough to satisfactorily shield electromagnetic waves, such as gold, silver, copper, iron, nickel, and chromium, may be used as a material for the metal layer 21. The metal layer 21 may be a layer of not only a single metal but also an alloy, and it may also be composed of multiple layers. Specifically, low-carbon steels such as low-carbon rimmed steels and low-carbon aluminum killed steels, Ni—Fe alloys, and invar alloys are herein preferred as iron materials. If cathodic electrodeposition is conducted as a blackening treatment, it is preferable to use a copper foil or a copper alloy foil as a metal layer because it is easy to electrodeposit a blackening layer on such a material. Although it is possible to use both rolled copper foil and electrolytic copper foil as the copper foil, electrolytic copper foil is preferred because of its uniformity in thickness and of excellent adhesion to a layer formed by blackening treatment and/or chromate treatment and because it can have a thickness as small as below 10 μm.

The thickness of the metal layer 21 is approximately from 1 to 100 μm, and preferably from 5 to 20 μm. If the metal layer 21 has a thickness smaller than the above range, although it can be photolithographically processed into a mesh with ease, it has an increased electrical resistance value and thus has impaired electromagnetic wave shielding effect. On the other hand, when the metal layer 21 has a thickness in excess of the above range, it cannot be made into the desired fine mesh. Consequently, the mesh has a decreased substantial opening rate and a decreased light transmittance, which leads to decrease in viewing angle and to deterioration of image visibility.

It is preferable that surface roughness of the metal layer 21 is from 0.1 to 10 μm as the Rz value. The surface roughness Rz is a mean value of 10 measurements obtained in accordance with JIS-B0601 (1994 version).

In order to prevent deterioration of the image contrast by reflection of extraneous light especially at the surface of the metal layer, it is preferable that the surface roughness of the metal layer 21 is 0.5 μm or more. In addition, in particular, in order to surely peel off the ionizing radiation cured resin layer from the metal layer surface, it is preferable that the Rz value of the metal layer 21 is 1.5 μm or less. Therefore, the preferable range of Rz is 0.5 to 1.5 μm. The surface roughness Rz is average roughness of 10 measurements obtained in accordance with JIS-B0601. If the metal layer 21 has surface roughness lower than the above range, the extraneous light is mirror reflected so that the image visibility is deteriorated, even if a blackening treatment is conducted. If the metal layer 21 has surface roughness higher than the above range, an adhesive or resist, upon application thereof, does not spread over the entire surface, and/or causes incorporation of air to contain air bubbles, and/or the ionizing radiation cured resin layer is not removed from the metal layer completely during the peeling-off step in the method for producing an electromagnetic wave shielding sheet and it is difficult to expose the metal layer.

### (Blackening Layer)

In this specification, the metal layer 21 is simply shown. However, as shown in FIG. 4, if required, a blackening layer 25 (25A, 25B) and/or an anticorrosive layer 23 (23A, 23B) and other optional layers may be provided on at least one surface of the metal layer 21.

For forming the blackening layer, that is, as a blackening treatment, the surface of the metal layer 21 may be roughened and/or blackened. Specifically, a variety of methods including a method of depositing a metal, alloy, metal oxide, or metal sulfide may be employed. Preferred methods useful for conducting the blackening treatment include plating. Plating makes it possible to form a blackening layer on the metal layer with good adhesion and to uniformly blacken the surface of the metal layer with ease. At least one metal selected from copper, cobalt, nickel, zinc, molybdenum, tin, and chromium, or a compound thereof may be used as a material for the plating. When the other metals or compounds are used, the metal layer cannot be fully blackened, or the adhesion of the blackening layer to the metal layer is insufficient. These problems occur significantly in a case wherein cadmium is used for plating, for example.

A plating process that is favorably employed when a copper foil is used as the metal layer 21 is cathodic electrodeposition plating, in which the copper foil is subjected to cathodic electrolysis in an electrolyte such as sulfuric acid, copper sulfate, or cobalt sulfate, thereby depositing cationic particles on the copper foil. The cationic particles deposited on the surface of the metal layer in the above-described manner roughen this surface more greatly, and, at the same time, make the metal layer black in color. Although copper particles as well as particles of alloys of copper and other metals may be used as the cationic particles, it is herein preferable to use copper-cobalt alloy particles. The mean particle diameter of the copper-cobalt alloy particles is preferably from 0.1 to 1 μm. The cathodic electrodeposition described above is convenient to deposit uniformly sized particles with a mean particle diameter of 0.1 to 1 μm. Further, if treated at high current density, the surface of the copper foil becomes cathodic and generates reducing hydrogen to get activated, so that significantly improved adhesion can be obtained between the copper foil and the particles.

If the mean particle diameter of the copper-cobalt alloy particles is made outside the above-described range, the following problem occurs. When the mean particle diameter of the copper-cobalt alloy particles is made greater than the above range, the metal layer is not satisfactorily blackened, and, moreover, falling of the deposited particles (also referred to as falling of the powdery coating) easily occurs. In addition, the external appearance of the agglomerated particles becomes poor in denseness, and the appearance and light absorption become noticeably non-uniform. On the other hand, copper-cobalt alloy particles with a mean particle diameter smaller than the above-described range are also insufficient in the ability to blacken the metal layer and cannot fully prevent reflection of extraneous light to lower image visibility. In addition, if the mean particle diameter of the copper-cobalt alloy particles is made outside the above-described range, it is difficult to maintain the Rz value of the surface of the frame part opposite to the adhesive layer within the optimum range of 0.5 to 1.5 μm.

### (Structure of Layers)

The anticorrosive layer 23 has the function of protecting the metal layer 21 and its blackened surface 25 from corrosion. In addition, the anticorrosive layer 23 prevents falling or deformation of the blackening particles at the blackened surface. Moreover, the blackening layer 25 can be made blacker by the anticorrosive layer 23. The reason why the anticorrosive layer 23 is formed in the above manner is explained as follows. That is, in a period before the blackening layer 25 is laminated to the transparent substrate 11, it is necessary to prevent the blackening layer 25 from falling and degradation, so that the anticorrosive layer 23 is needed to be formed before the laminating step in order to protect the blackening layer 25. Conventionally known anticorrosive layers may be used as the anticorrosive layer 23. Preferably, metals such as chromium, zinc, nickel, tin, and copper, alloys thereof, oxides of these metals, and other compounds of these metals are useful as a material for the anticorrosive layer 23. Preferably, chromium compound layers obtained by conducting plating with zinc, followed by chromate treatment, are used as the anticorrosive layer 23. In order to increase resistance to acids that is needed when etching and washing with an acid are conducted, it is preferable to incorporate a silicon compound in the anticorrosive layer 23, and such a silicon compound include a silane-coupling agent. In addition, the anticorrosive layer 23 is preferably excellent in adhesion to the blackening layer 25 (especially, a copper-cobalt alloy particle layer) and to the adhesive layer 13 (especially, a two-pack curable urethane resin adhesive layer).

A conventional plating process may be used to form a layer of any of the above-described metals such as chromium, zinc, nickel, tin, and copper, alloys thereof, and compounds thereof. To form a chromium compound layer, conventional plating or chromate (chromic acid salt) treatment may be conducted, for example. The thickness of the anticorrosive layer is approximately 0.001 to 10 μm, preferably 0.01 to 1 μm. For forming the anticorrosive layer 23, one side of the blackened substrate may be subjected to chromate treatment that is conducted by coating or flow coating, or both sides of the blackened substrate may be simultaneously subjected to chromate treatment that is conducted by dipping.

### (Chromate Treatment)

Chromate treatment is that a chromate treatment liquid is applied to a material to be treated. To apply a chromate treatment liquid, roll coating, curtain coating, squeeze coating, electrostatic spraying, dip coating, or the like may be employed, and the chromate treatment liquid applied is dried without being washed with water. An aqueous solution containing chromic acid is usually used as the chromate treatment liquid. Specific examples of chromate treatment liquids useful herein include Alsurf 1000 (trade name of a chromate treatment liquid manufactured by Nippon Paint Co., Ltd., Japan), and PM-284 (trade name of a chromate treatment liquid manufactured by Nippon Parkerizing Co., Ltd., Japan). It is preferable to conduct zinc plating prior to the above-described chromate treatment. If zinc plating is so conducted, the blackening layer/the anticorrosive layer (two layers of zinc layer/chromate treatment layer) is obtained, and this structure can bring about further enhancement of interlaminar bonding, anticorrosion, and blackening effect.

### (Second Step)

This step is a step of laminating one surface of the metal layer 21 and the transparent substrate via adhesive agents.

### (Transparent Substrate)

A variety of materials having transparency, insulating properties, heat resistance, mechanical strength, and so on good enough to withstand service conditions and production conditions can be used for the transparent substrate 11. Examples of materials useful herein include glass and transparent resins.

Of the materials useful for the transparent substrate 11, glass includes silica glass, borosilicate glass, and soda-lime glass, and it is preferable to use non-alkali glass which contains no alkali components and which has a low rate of thermal expansion and is excellent in dimensional stability and also in working properties in high-temperature heat treatment. If such non-alkali glass is used, the transparent substrate can be made to serve also as a substrate for an electrode.

On the other hand, transparent resins useful for the transparent substrate 11 include polyester resins such as polyethylene terephthalate, polybutylene terephthalate, polyethylene naphthalate, terephthalic acid—isophthalic acid—ethylene glycol copolymers, and terephthalic acid—cyclohexane dimethanol—ethylene glycol copolymers; polyamide resins such as nylon 6; polyolefin resins such as polypropylene and polymethyl pentene; acrylic resins such as polymethyl methacrylate; styrene resins such as polystyrene and styrene—acrylonitrile copolymers; cellulose resins such as triacetyl cellulose; imide resins; and polycarbonate.

The transparent-resin-made transparent substrate 11 may be made from a copolymer resin or mixture (including an alloy) containing, as a main component, any of the above-enumerated resins, and may also be a laminate of two or more layers. Such a transparent substrate 11 may be either an oriented or non-oriented film; however, in order to obtain increased strength, it is preferable to use a mono- or bi-axially oriented film. Generally, it is preferred that the transparent substrate 11 made from a transparent resin has a thickness of approximately 12 to 1000 μm, more preferably 50 to 700 μm, optimally 100 to 500 μm. On the other hand, approximately 1000 to 5000 μm is generally proper for the thickness of the transparent substrate made of glass. In either case, a transparent substrate with a thickness smaller than the above range cannot have sufficiently high mechanical strength, so that it curls, becomes wavy, or is broken; while a transparent substrate with a thickness greater than the above range has excessively high strength, which is wasteful from the viewpoint of cost.

In general, a film of a polyester resin such as polyethylene terephthalate or polyethylene naphthalate, a cellulose resin film, or a glass plate is conveniently used as the transparent substrate 11 because it is excellent in both transparency and heat resistance and is also inexpensive. Of these materials, a polyethylene terephthalate film is most preferred because it is hard to break, is light in weight, and is easy to form. A transparent substrate having higher transparency is more useful, and the preferred transparency of the transparent substrate, as expressed as a transmittance for visible light, is 80% or more.

Prior to the application of an adhesive, the transparent substrate 11 (e.g., a transparent substrate film) to be coated with the adhesive may be subjected to adhesion-promoting treatment such as corona discharge treatment, plasma treatment, ozone treatment, flame treatment, primer (also referred to as anchoring, adhesion-promoting or adhesion-improving agent) coating treatment, preheating treatment, dust-removing treatment, vacuum deposition, or alkali treatment. Additives such as ultraviolet light absorbers, fillers, plasticizers, and antistatic agents may be optionally incorporated in transparent resin films useful for the transparent substrate 11.

### (Method of Laminating)

The transparent substrate 11 and the metal layer 21 are laminated with the adhesive. In this laminating process, an adhesive resin is made into a fluid such as a heated molten resin, an uncross-linked polymer, a latex, an aqueous dispersion, or an organic solvent solution, which is then printed on or applied to the surface of the transparent substrate 11 and/or the metal layer 21 by a conventional printing or coating method such as screen printing, gravure printing, comma coating, or roll coating. Then, the adhesive resin is dried, if necessary, and is superposed on the other member, and pressure is exerted. Thereafter, the adhesive resin layer is cured. The thickness of the adhesive layer (when dried) is about 0.1 to 20 μm, preferably 1 to 10 μm.

Specifically, after applying an adhesive to the surface of the metal layer 21 and/or the transparent substrate 11 and drying the adhesive applied, the other member is superposed on the adhesive layer, and pressure is then exerted. Then, the laminate is aged at 30 to 80° C. for several hours to several days, as needed, to cure the adhesive, to obtain a laminate that can be wound up. It is preferable to use a method that is called dry laminating by those skilled in the art. In addition, it is preferable to use ionizing radiation curing resin that can be cured in ionizing radiation such as ultraviolet light (UV) or electron beams (EB).

### (Dry Laminating)

Dry laminating is a method of laminating two members in the following manner: by a coating method such as a roll, reverse roll, or gravure coating, a solvent in which an adhesive has been dispersed or dissolved is applied to one of the two members to form a film so that the film after dried has a thickness of approximately 0.1 to 20 μm, preferably 1 to 10 μm, and the solvent is evaporated, thereby forming an adhesive layer; after forming the adhesive layer, the other laminating member is superposed on the adhesive layer; and this laminate is aged at 30 to 80° C. for several hours to several days, as needed, to cure the adhesive.

The material for the adhesive layer useful in this dry laminating includes thermosetting adhesives and ionizing radiation curing adhesives. Specific examples of thermosetting adhesives useful herein include two-pack curable urethane adhesives obtainable by the reaction of polyfunctional isocyanates such as tolylene diisocyanate or hexamethylene diisocyanate with hydroxyl-group-containing compounds such as polyether polyols or polyacrylate polyols; acrylic adhesives; and rubber adhesives. Of these, two-pack curable urethane adhesives are preferred.

### (Third Step)

This step is a step of photolithographically making, into a mesh pattern, the metal layer laminated to the transparent substrate.

### (Photolithography)

A mesh-patterned resist layer is provided on the surface of the metal layer of the laminate, portions of the metal layer that are not covered with the resist layer are etched, and then the resist layer is removed (Photolithography Method). Thus, the metal layer is made into a mesh electromagnetic wave shielding layer.

As shown in FIG. 1, a plan view, the electromagnetic wave shielding layer consists of a mesh part 103 and a frame part 101. Further, as shown in FIG. 2, a perspective view, and in FIG. 3, a sectional view, in the mesh part 103, a plurality of openings 105 is defined by line parts 107, which are the remaining metal layer. On the other hand, the frame part 101 entirely consists of the remaining metal layer having no openings. The frame part 101 is optional and may be provided so that it surrounds the mesh part 103 or stretches in a part of the area surrounding the mesh part 103.

Also in this step, a belt-shaped laminate in the state of a continuously wound-up roll is processed. Namely, while such a laminate is fed either continuously or intermittently under a stretched and non-loosened state, masking, etching, and resist stripping are conducted. Masking is conducted in the following manner, for example: first, a photosensitive resist is applied to the metal layer and is dried; this resist layer is subjected to contact exposure, using an original plate (photo mask) with a predetermined pattern (the line parts of the mesh part and the frame part); thereafter, development with water, film-hardening treatment, and baking are conducted.

The resist is applied in the following manner: while the stretched belt-like laminate is continuously or intermittently fed, a resist made from casein, PVA, or gelatin is applied to the metal layer surface by such a method as dipping (immersion), curtain coating, or flow coating. Alternatively, a dry film resist may be used as the resist; the use of a dry film resist can improve working efficiency. When casein is used for the resist, the above-described baking is usually conducted at 200 to 300° C. However, in order to prevent the laminate from curling, it is preferable to conduct the baking at a temperature of 100° C. or lower, as low as possible.

### (Etching)

The etching of the laminate is conducted after the masking of the laminate. Since the laminate is etched continuously in the present invention, it is preferable to use, as an etchant, a ferric or cupric chloride solution that can be readily circulated. The etching of the laminate is basically the same process as in the production of shadow masks for cathode ray tubes of color TVs, in which belt-shaped continuous steel stock with a thickness of 20 to 80 μm is etched. It is thus possible to use, for etching the laminate, the existing facilities for the production of shadow masks, and to continuously conduct a series of the steps of from masking to etching, so that the production efficiency is extremely high. The laminate etched in the above-described manner is subjected to washing with water, stripping of the resist with an alkaline solution, and cleaning, and is then dried.

### (Mesh)

The mesh part 103 is an area surrounded by the frame part 101. The mesh part 103 has line parts 107 that define a plurality of openings 105. There are no limitations on the shape of the openings 105, and examples of the shape of the openings 105 useful herein include triangles such as equilateral triangles, squares such as regular squares, rectangles, rhombuses, and trapezoids, polygons such as hexagon, circles, and ovals. The mesh part 103 may have openings that are a combination of openings in two or more different shapes.

From the viewpoint of the opening rate and the non-recognizability of the mesh part, it is preferred that the line width of the mesh part 103 be 50 μm or less, preferably 20 μm or less. From the viewpoint of light transmittance, it is preferred that the distance between the lines (line pitch) of the mesh part 103 be 150 μm or more, preferably 200 μm or more. In order to avoid occurrence of moiré fringes or the like, the bias angle (the angle between the line parts of the mesh part and the sides (edges) of the electromagnetic wave shielding sheet) may be properly selected with consideration for the pixel and emission properties of a display.

### (Fourth Step)

This step is a step of: applying ionizing radiation curing resin onto the metal layer surfaces at the mesh part and the frame part, laminating a pattern-transfer film onto the ionizing radiation curing resin, and applying ionizing radiation to the laminate on a side of the pattern-transfer film, thereby curing the ionizing radiation curing resin.

### (Ionizing Radiation Curing Resin Layer)

The ionizing radiation cured resin layer 33 is made from the ionizing radiation curing resin, which is liquid and can be cross-linked and/or polymerized by application of ionizing radiation such as ultraviolet light (rays) or electron beam.

Mainly, a radically polymerizable oligomer or monomer having, in its molecule, an ethylenic double bond such as acryloyl group, methacryloyl group, acryloyloxy group, or methacryloyloxy group can be used as an oligomer or monomer forming the ionizing radiation curing resin. Besides, a cationically polymerizable oligomer and/or monomer, such as an epoxy-group-containing compound, can be used as well.

Examples of the radically polymerizable oligomer or monomer having an ethylenic double bond include polyester resins, polyether resins, acrylic resins, epoxy resins, urethane resins, alkyd resins, spiroacetal resins, polybutadiene resins, polythiolpolyene resins, and oligomers or prepolymers of (meth)acrylates or the like of polyfunctional compounds such as polyhydric alcohols (where the term “(meth)acrylates” means “acrylates or methacrylates”). Oligomers or monomers of radically polymerizable monomers having ethylenic double bonds that will be described in the next paragraph are also useful herein.

Examples of radically polymerizable monomers having ethylenic double bonds include monofunctional (meth)acrylates such as ethyl (meth)acrylate, ethylhexyl (meth)acrylate, 2-hydroxyethyl (meth)acrylate, 2-hydroxypropyl (meth)acrylate, hydroxybutyl (meth)acrylate, 2-hydroxy-3-phenoxypropyl (meth)acrylate, carboxypolycaprolactone (meth)acrylate, and (meth)acrylamide; bifunctional (meth)acrylates such as 1,6-hexanediol di(meth)acrylate, neopentyl glycol di(meth)acrylate, ethylene glycol diacrylate, tripropylene glycol di(meth)acrylate, diethylene glycol di(meth)acrylate, and pentaerythritol di(meth)acrylate monostearate; trifunctional (meth)acrylates such as trimethylol propane tri(meth)acrylate and pentaerythritol tri(meth)acrylate; polyfunctional (meth)acrylates such as pentaerythritol tetra(meth)acrylate and dipentaerythritol hexa(meth)acrylate; and monofunctional monomers such as acrylic acid, methacrylic acid, styrene, methylstyrene, and N-vinylpyrrolidone. These monomers can also be used as a diluent.

A compound selected from acetophenone, benzophenone, ketals, anthraquinones, thioxanthone, thioxanthone, azo compounds, peroxides, 2,3-dialkyldione compounds, disulfide compounds, thiuram compounds, fluoroamine compounds, and the like can be used as a photopolymerization initiator that is optionally added when a radically polymerizable oligomer or monomer having an ethylenic double bond is used.

Specific examples of the photopolymerization initiator include 1-hydroxy-cyclohexyl-phenyl-ketone (manufactured by Ciba Specialty Chemicals K.K., Japan, marketed under the trade name Irgacure 184), 2-methyl-1[4-(methylthio)phenyl]-2-morpholinopropan-1-one (manufactured by Ciba Specialty Chemicals K.K., Japan, marketed under the trade name Irgacure 907), benzyl dimethyl ketone, 1-(4-dodecylphenyl)-2-hydroxy-2-methylpropan-1-one, 2-hydroxy-2-methyl-1-phenylpropan-1-one, 1-(4-isopropylphenyl)-2-hydroxy-2-methylpropan-1-one, and benzophenone. One of, or two or more of these compounds may be used as the photopolymerization initiator.

### (Ionizing Radiation)

The ionizing radiation means electromagnetic wave or charged-particle wave having energy quantum large enough to cross-link and/or polymerize molecules. In general, as ionizing radiation, ultraviolet light, electron beam or the like is used. When the ultraviolet light is used, as irradiation equipment (radiation source), a high-pressure mercury vapor lamp, a low/high-pressure mercury vapor lamp, a metal halide lamp, a carbon arc, a black light lamp, and the like may be used. It is preferable that energy (wavelength) of the ultraviolet light is about 190 to 380 nm, and that exposed dose is about 50 to 1000 mj/cm². When the electron beam is used, as irradiation equipment (radiation source), a variety of electron-beam accelerators including Cockcroft-Walton type, Van-de-Graaff type, resonance-transformer type, insulation-core-transformer type, linear type, dynamitron type or radio-frequency type may be used. It is preferable that energy (accelerating voltage) of the electron beam is 70 to 1000 keV, preferably about 100 to 300 keV, and that exposed dose is usually about 0.5 to 30 Mrad. Herein, in a case of using the electron beam, the ionizing radiation curing resin may not include polymerization initiators.

### (Pattern-Transfer Film)

The pattern-transfer film 41 is provided for forcibly making flat the surface of the ionizing radiation curing resin applied on the metal layer while the applied resin is still liquid. Thus, a surface of the pattern-transfer film on a side of the resin applied is a desired flat surface. In addition, the pattern-transfer film has releasability to the ionizing radiation cured resin made from the ionizing radiation curing resin. Herein, the “flat surface” includes flatness at which: no air bubbles can remain when the adhesive layer is applied thereon, a displayed image is not deflected, and no haze is generated by light diffusion. In other words, if no image deflection and no haze is generated, the flat surface can have some minute irregularities (matted state), in order to prevent surface blocking and pyramid phenomenon. (In the surface of the pattern-transfer film, irregularities of substantially the same period as the irregularities of the mesh part can be practically ignored, and the step of the irregularities of the pattern-transfer film is considerably smaller than that of the mesh part. That is, the surface of the pattern-transfer film may be a flat surface in general (overall) view, with some minute irregularities locally overlapped on the flat surface, the minute irregularities having smaller period and step than those of the mesh part.) Herein, the minute irregularities can be provided by conducting to the surface a positive process such as embossing, stamping, mixing of particles, or chemical etching. Such a film is called a mat film or the like. In addition, if the surface of the applied ionizing radiation curing resin is exposed as an outermost surface of the electromagnetic wave shielding sheet, some minute irregularities may be provided on that surface within a scope of generating no deflection and no haze of the image, so that a function of preventing light reflection is given by the minute irregularities.

A variety of materials that meet the following requirements can be used for the pattern-transfer (shaping) film 41: the material can be made into a film with the desired smooth surface; the material is releasable from a cured product of an ionizing radiation curing resin; the material has mechanical strength high enough to withstand release (separation); etc. In the case where ultraviolet light (UV) is used as the ionizing radiation, a material having permeability to ultraviolet light is selected. Such a material is a synthetic or natural resin, for example. Examples of synthetic or natural resins useful herein include polyester resins such as polyethylene terephthalate, polybutylene terephthalate, polyethylene naphthalate, ethylene glycol—terephthalic acid—isophthalic acid copolymers, and terephthalic acid—cyclohexane dimethanol—ethylene glycol copolymers; polyamide resins such as nylon 6; polyolefin resins such as polypropylene, polymethylpentene, and cyclic polyolefins; imide resins; and polycarbonate. The resin film surface on which the ionizing radiation curing resin film will be formed may optionally be coated with a releasing layer, and, moreover, additives such as fillers, plasticizers, and antistatic agents can be incorporated in the resin film, as needed.

The pattern-transfer film 41 may be made from a copolymer resin or mixture (including an alloy) containing, as a main component, any of the above-enumerated resins, and may also be a laminate of two or more layers. Such a pattern-transfer film 41 may be either an oriented or non-oriented film; however, in order to obtain increased strength, it is preferable to use a mono- or bi-axially oriented film. Generally, it is preferred that the pattern-transfer film 41 has a thickness of approximately 12 to 1000 μm, more preferably 50 to 700 μm, optimally 75 to 250 μm. A pattern-transfer film with a thickness smaller than the above range cannot have sufficiently high mechanical strength, so that it curls, becomes wavy, or is broken; while a pattern-transfer film with a thickness greater than the above range has poor deformability, which results in difficulty in the peeling-off thereof, and excessively high strength, which is wasteful from the viewpoint of cost.

In general, it is convenient to use, as the pattern-transfer film, a film of a polyester resin such as polyethylene terephthalate or polyethylene naphthalate, or a film of a polyolefin resin such as polypropylene or polynorbornene from the viewpoint of smoothness, strength, release properties, permeability to ultraviolet light, resistance to heat, and cost. A biaxially oriented polyethylene terephthalate film is most preferred.

Regarding the surface of the pattern-transfer film 41 on the side of the applied resin, higher releasability (lower surface wettability) is not always better. That is, it is necessary to adjust the surface to appropriate releasability (easiness of adhesion). Preferably, the surface of pattern-transfer film 41 to be in contact with the ionizing radiation curing resin has surface wettability of 35 to 45 mN/m in accordance with JIS K-6768 (measurement results by a mixed liquid for testing wetted tensile force, manufactured by Wako Pure Chemical Industries, Ltd., Japan). In order to adjust the surface wettability within the above range, the surface is subjected to adhesion-promoting treatment such as corona discharge treatment, plasma treatment, ozone treatment, flame treatment, primer (also referred to as anchoring, adhesion-promoting or adhesion-improving agent) coating treatment, preheating treatment, dust-removing treatment, vacuum deposition, or alkali treatment.

In order to improve the surface wettability, from the viewpoint of easiness and reliability of treatment, corona discharge treatment is preferably conducted. If the surface wettability is adjusted, the interlayer adhesive forces of the present invention can be adjusted into the following relationship: the interlayer adhesive force between the adhesive layer 13 and the ionizing radiation cured resin layer 33>the interlayer adhesive force between the ionizing radiation cured resin layer 33 and the pattern-transfer film 41>the interlayer adhesive force between the ionizing radiation cured resin layer 33 and the metal layer 21. Then, when the interlayer adhesive forces are adjusted as described above, during the peeling-off step of the pattern-transfer film 41, as shown in FIG. 6(D), only the ionizing radiation cured resin 33 on the metal layer 21 is removed under a state in close contact with the pattern-transfer film 41, and the ionizing radiation cured resin 33 on the adhesive layer 13 is left on the adhesive layer 13 away from the pattern-transfer film 41.

### (Producing Method)

Next, a method of producing an electromagnetic shielding sheet according to the present invention is explained, taking an example of using UV (ultraviolet light).

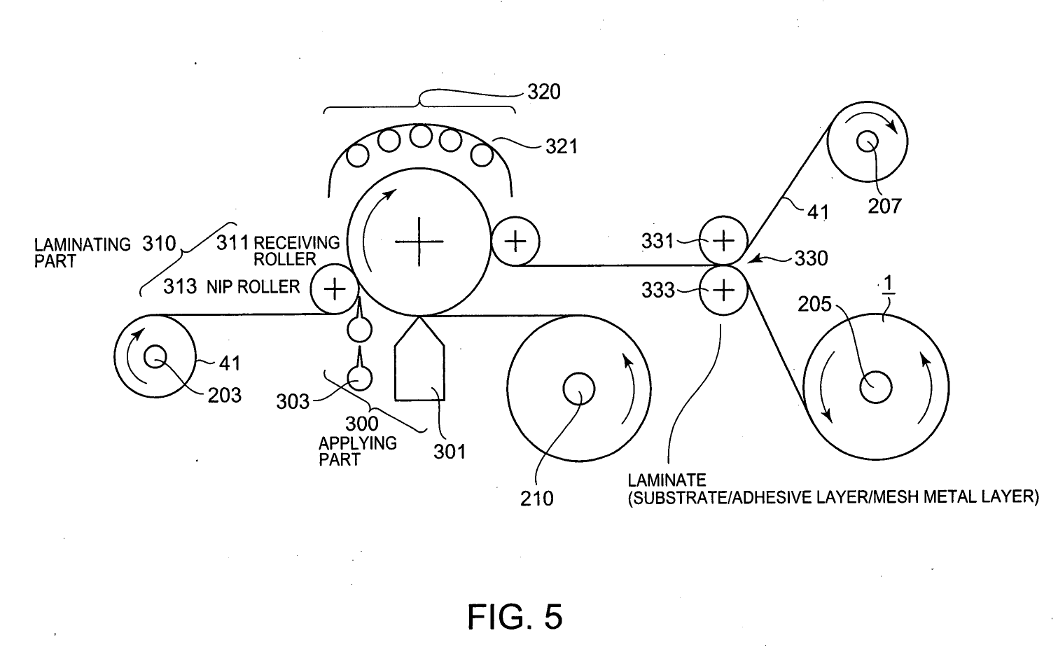

FIG. 5 is a schematic sectional view showing a main part of a producing system used for a method of producing an electromagnetic wave shielding sheet according to an embodiment of the present invention.

FIG. 6 are sectional views of a main part of an electromagnetic wave shielding sheet for explanation of a peeling-off state during a method for producing an electromagnetic wave shielding sheet according to an embodiment of the present invention.

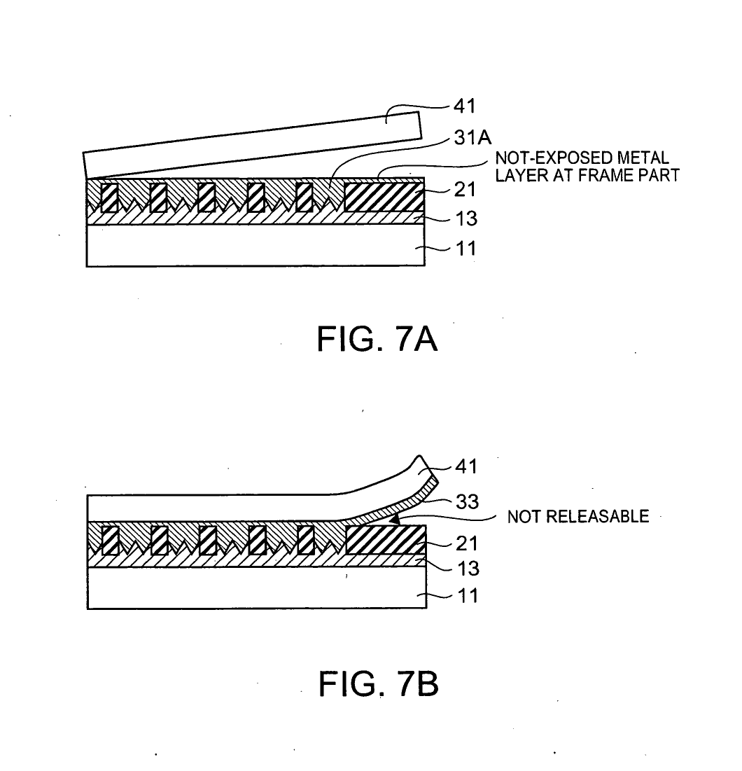

FIGS. 7(A) and 7(B) are sectional views of a main part of an electromagnetic wave shielding sheet for explanation of a peeling-off state during a method for producing an electromagnetic wave shielding sheet as a comparison.

### (Fourth Step-1: Application of Ionizing Radiation Curing Resin 31 to the Metal Layer Surface at the Mesh Part and the Frame Part)

As shown in FIG. 5, from a first feeding part 201, a laminate as shown in FIG. 6(B) (transparent substrate 11/adhesive layer 13/metal layer 21 (mesh part and frame part)) is fed. The laminate runs on a surface of a receiving roller 311. An excessive amount of (compounds of) ionizing radiation curing resin, which is liquid before being cured, is supplied from a coating (applying) apparatus 301, and is applied to the metal layer 21 by the same apparatus 301.

The coating apparatus 301 is provided for applying the (compounds of) ionizing radiation curing resin. Preferably, the coating apparatus 301 is a nozzle coating apparatus. In a nozzle coating apparatus useful herein, a nozzle of a predetermined size has an ejecting port of a T-die shape, a rectangular shape or a linear shape, and the longitudinal direction of the ejecting port is aligned in a direction (width direction) perpendicular to the rotation direction of the receiving roller 311. In addition, a discharging apparatus is provided so as to cover a predetermined width of the receiving roller 311 among the entire width thereof, for pressing the ionizing radiation curing resin liquid into a curtain shape and discharging it onto the receiving roller 311. In the nozzle coating apparatus, a cavity may be provided in a liquid supplying passage in the nozzle, in order to inhibit nonuniformity and variation with time of the discharged amount. In addition, it is preferable that the resin is applied only to the mesh part, intermittently, by a required amount thereof.

In addition, as the coating apparatus 301, any other coating apparatus may be adopted, using a roll coating method, a knife coating method, a blade coating method, a comma coating method, a slit coating method, or a dispenser method.

As a material of the receiving roller 311, a metal such as copper, chromium or iron, synthetic resin such as NBR, epoxy or ebonite, or ceramics such as glass may be used. The size of the receiving roller 311 is not limited, and may be suitably selected depending on the size of the sheet intended to manufacture. In addition, the receiving roller 311 is adapted to be rotated in the direction shown by an arrow, by a driving apparatus (not shown).

### (Fourth Step-2: Lamination of Pattern-Transfer Film)

A pattern-transfer film 41 is fed from a second feeding part 203, and is laminated to the above laminate running together with the receiving roller 311 by receiving a pressure from a nip roller 313. The above laminate and the pattern-transfer film 41 run under a laminated and overlapped state. When the nip roller 313 applies the pressure to the pattern-transfer film 41, the compounds of the ionizing radiation curing resin are pressed to the transparent substrate 11 by the pressurizing force in a nominal direction of the film tensile force. Then, the compounds of the ionizing radiation curing resin are filled in the openings 105 of the mesh part, in spite of viscosity and curing shrinkage of the compounds of the ionizing radiation curing resin. Thus, the compounds of the ionizing radiation curing resin fills up the rough surface of the adhesive layer 13 exposed at the openings 105 (concave portions at the openings 105). In addition, the compounds of the ionizing radiation curing resin are thinly applied to the surface of the metal layer 21 at the line parts 107 and the frame part 101. The excessive liquid 303 is suitably removed, so that the state as shown in FIG. 6(C) is brought about.

### (Thickness)

The thickness of the ionizing radiation cured resin 33 is not limited, and sufficient to fill up at least the openings 105 at the mesh part. Regarding the thickness of the ionizing radiation cured resin layer thinly provided on the metal layer 21, thinner thickness is better, in order to separate a portion remaining on the laminate from a portion remaining on the pattern-transfer film at their border by cohesion failure during the peeling-off step of the pattern-transfer film 41. Specific thickness of the ionizing radiation cured resin 33 is suitably selected with consideration for volume of the openings 105 at the mesh part. Usually, the maximum thickness is about 1 to 110 μm, including the thickness of the metal layer, preferably about 1 to 100 μm, and the thickness of the resin layer, preferably about 0.1 to 10 μm.

### (Viscosity)

At that time, it is sufficient that the compounds of the ionizing radiation curing resin have viscosity of about 500 to 3000 cps, i.e., are in a solventless state. If such a state is obtained by a drying step or the like, compounds of the ionizing radiation curing resin including some solvent may be used as well. As a method of controlling the viscosity of the compounds of the ionizing radiation curing resin to a predetermined value, a method of making the inside of the receiving roller hollow, and causing a fluid such as water, oil or vapor adjusted to an appropriate temperature to flow in and out from the hollow portion in order to control the surface temperature of the receiving roller to a predetermined value, may be used. In general, the viscosity is decreased at a higher temperature. However, at a too high temperature, the compounds of the ionizing radiation curing resin may be decomposed and/or evaporated. Thus, the temperature is preferably about 15° C. to 50° C., although it exactly depends on the resin.

Herein, it is possible to adopt a method of applying the compounds of the ionizing radiation curing resin to the pattern-transfer film 41, and pressing the receiving roller 311 and the nip roller 313 toward the laminate, although it is not shown in the drawings and not explained in detail. However, in order to prevent air incorporation and surely fill up the roughness of the exposed surface of the adhesive layer, it is preferable that the compounds of the ionizing radiation curing resin are applied to the metal layer 21 (mesh part) of the laminate.

In a conventional electromagnetic wave shielding sheet, it has been unavoidable that air is incorporated in the mesh part to form air bubbles when laminating the metal layer having the mesh part and the other member coated with a pressure-sensitive adhesive. For this reason, the step of removing the air bubbles in order to make the mesh part transparent has been specially conducted. This step is a batch-wise process that is conducted in the following manner, for example: the laminate is placed in a pressure-resistant, expensive closed vessel, such as an autoclave, is heated to a temperature of approximately 30 to 100° C., and is treated by either pressurizing or decompressing, or pressurizing and decompressing the closed vessel for a period of time as long as 30 to 60 minutes. On the contrary, such an inefficient step is not needed for the producing method according to the invention.

### (Fourth Step-3)

next, at an irradiation/curing part 320, ionizing radiation is irradiated to the laminate on the side of the pattern-transfer film. In the case shown in FIG. 5, ultraviolet light radiated from UV irradiation equipment 321 is irradiated to the laminate. When the ultraviolet light is irradiated, the ultraviolet light permeates the pattern-transfer film 41 and reaches the compounds of the ionizing radiation curing resin.

### (Fourth Step-4)

Then, the ionizing radiation curing resin 31 is cured. That is, the ionizing radiation curing resin is cured by the UV to become the ionizing radiation cured resin 33. Herein, in order to completely cure the ionizing radiation cured resin after peeled off from the receiving roller 311, a post-curing apparatus may be provided.

### (Fifth Step)

This step is a step of: peeling off the pattern-transfer film and removing a portion of the ionizing radiation cured resin in contact with the metal layer at the frame part together with the pattern-transfer film.

As shown in FIG. 5, the peeling-off step is conducted after the application of the ionizing radiation curing resin, the lamination of the pattern-transfer film, and the irradiation of the ultraviolet light. While the laminate is fed from between two peeling-off rollers 331 and 333, an electromagnetic wave shielding sheet 1 is wound up by a first winding part 205, and the pattern-transfer film 41 is wound up by a second winding part 207, so that the sheet and the film are peeled off from each other. As shown in FIG. 6(D), when the pattern-transfer film 41 is peeled off, the ionizing radiation cured resin 33 located at least on the frame part, among the ionizing radiation cured resin 33 located on the metal layer 21, is removed under a state in close contact with the pattern-transfer film 41. On the other hand, the ionizing radiation cured resin 33 located on the adhesive layer 13 remains on the adhesive layer 13, separated away from the pattern-transfer film 41.

### (Effect)

In the electromagnetic wave shielding sheet 1 manufactured in the above manner, as shown in FIG. 6(E), the surface irregularities of the adhesive layer 13 exposed at the openings 105 of the mesh part are covered and filled with the ionizing radiation cured resin, so that the rough surface is optically eliminated. In addition, the surface of the ionizing radiation cured resin is made flat. The surface is transferred by the flat surface shape of the pattern-transfer film 41, and hence is made flat. When a film having a smooth surface is used as a pattern-transfer film 41, the surface of the ionizing radiation cured resin is also made smooth. When a film having a mat (matted) surface is used as a pattern-transfer film 41, the surface of the ionizing radiation cured resin also corresponds to the mat surface. That is, if the mat shape has a function of preventing reflection, such a function is obtained. On the other hand, at the frame part 101, the ionizing radiation cured resin 33 is removed from on the metal layer 21, so that the surface of the metal layer 21 is exposed. The surface of the metal layer may be used as a ground (earth) terminal.

If the exposed surface of the openings at the mesh part is rough, the surface irregularly reflects extraneous light to increase reflectance. When such a sheet is mounted on a display such as a PDP, the sheet may deteriorate the image contrast. However, according to the electromagnetic wave shielding sheet 1 of the present invention, the roughness of the exposed surface of the adhesive layer at the openings of the mesh part is fully filled up, and the surface of the mesh openings is made flat, so that transparency enough not to impair visibility of a display screen can be maintained.

For the comparison shown in FIG. 7(A), surface-releasability treated polyethylene terephthalate was used as a pattern-transfer film 41, wherein the surface thereof to be contacted with the ionizing radiation curing resin layer had surface wettability of 30 mN/m accordingly to JIS K-6768 (measurement results by a mixed liquid for testing wetted tensile force, manufactured by Wako Pure Chemical Industries, Ltd., Japan). In the case, the interlayer adhesive forces were: the interlayer adhesive force between the adhesive layer 13 and the ionizing radiation cured resin layer 33>the interlayer adhesive force between the ionizing radiation cured resin layer 33 and the metal layer 21>the interlayer adhesive force between the ionizing radiation cured resin layer 33 and the pattern-transfer film 41. Thus, when the pattern-transfer film 41 is peeled off, only the pattern-transfer film 41 is peeled off and removed, so that the entire surface of the ionizing radiation cured resin 33 is left. As a result, the surface of the metal layer 21 at the frame part is not exposed, but keeps covered with the ionizing radiation cured resin 33. Thus, the surface is not used as a ground terminal. (However, in the case, it is sufficient to introduce a step of peeling-off only the resin on the metal layer after attaching a masking film or the like on the entire surface.)

For the comparison shown in FIG. 7(B), surface-adhesion-promoting treated polyethylene terephthalate was used as a pattern-transfer film 41 (whose surface wettability was 70 mN/m). In the case, the interlayer adhesive forces were: the interlayer adhesive force between the ionizing radiation cured resin layer 33 and the pattern-transfer film 41>the interlayer adhesive force between the ionizing radiation cured resin layer 33 and the metal layer 21; and the interlayer adhesive force between the ionizing radiation cured resin layer 33 and the pattern-transfer film 41 and the interlayer adhesive force between the adhesive layer 13 and the ionizing radiation cured resin layer 33 were very strong. Thus, when the pattern-transfer film 41 is peeled off, the ionizing radiation cured resin 33 on the metal layer 21 is removed, but the three layers of the adhesive layer 13, the ionizing radiation cured resin 33 and the pattern-transfer film 41 are not peeled off from each other, which can not be used as a product.

The electromagnetic wave shielding sheet of the present invention may be combined with another optical component to be a preferable front panel for a PDP. For example, when it is combined with a near infrared ray absorbing filter that absorbs near infrared ray emitted from the PDP, malfunction of a remote controller and optical communications equipment being used near the PDP is avoidable. In addition, when it is combined with a filter for preventing reflection and/or glare of light, reflection of extraneous light entering the PDP is suppressed, and the contrast and visibility of an image displayed is improved.

In the case, an optical component such as a filter of absorbing near infrared rays or a filter of preventing reflection and/or glare is stuck or applied to at least one surface of the electromagnetic wave shielding sheet of the present invention consisting of the transparent substrate 11/the adhesive layer 13/the metal layer 21 (mesh part 103) and the ionizing radiation cured resin 33 (mesh opening part 105). As a sticking method, the optical component may be stuck by a suitable pressure-sensitive adhesive. As an applying method, the surfaces of the metal layer 21 and the ionizing radiation cured resin 33 are subjected to adhesion-promoting treatment such as corona treatment or primer treatment, if necessary, and then a layer including functional agents such as near infrared ray absorbing agents, reflection preventing agents, and/or glare preventing agents is applied by a known applying method such as gravure printing or roll coating.

According to the electromagnetic wave shielding sheet of the present invention, since the frame part 101 of the metal layer 21 is exposed, the exposed part can be directly used for grounding. It is therefore not necessary to make a terminal, which has so far been conducted.

If a flexible material is selected for the transparent substrate 11, the material can be continuously fed in a belt-like manner from a roll-up (wound-up) state, and continuously or intermittently transferred to undergo various producing processes. Thus, a plurality of steps can be collectively conducted in one step, which improves productivity. Moreover, the existing productive facilities can be used for production.

### (Modified Manner)

The present invention encompasses the following modifications. That is, the above embodiment has been described with reference to the case where flexible rolled-up materials are used as the transparent substrate 11 and the pattern-transfer film 41. However, they may be made from inflexible flat sheets. In this case, the flat sheets cannot be continuously processed, but can be processed while they are intermittently fed, and there can be obtained the same effects and actions as those that are obtained in the above embodiment.

Hereinafter, with reference to specific examples and comparisons, the present invention is further explained in detail, but the present invention is not limited thereto.

### EXAMPLE 1

10-μm thick electrolytic copper foil having, on one surface, a blackening layer made from copper-cobalt alloy particles, was used as the metal layer 21. A 100-μm thick PET film A4300 (trade name of polyethylene terephthalate manufactured by Toyobo Co., Ltd., Japan) was used as the transparent substrate 11. The transparent substrate 11 and the blackening layer of the metal layer 21 were dry-laminated with a urethane adhesive, and were then aged at 50° C. for 3 days, thereby obtaining a laminate. For the adhesive were used a main agent Takelack A-310 (trade name, manufactured by Takeda Chemical Industries, Ltd., Japan) consisting of polyester urethane polyol, and a curing agent A-10 (trade name, manufactured by Takeda Chemical Industries, Ltd., Japan) consisting of hexamethylene diisocyanate. The adhesive was applied in such an amount that the dried adhesive layer had a thickness of 7 μm. Then, the transparent adhesive layer 13 was formed.

The photolithographically forming step of the mesh pattern was conducted by the existing production line for shadow masks for color TVs, in which the laminate in the form of a continuous belt-like material was subjected to a series of the steps of from masking to etching. Specifically, at first, a casein photoresist was applied to the entire metal layer face of the laminate by flow coating. This laminate was intermittently carried to the next station, where the resist layer was subjected to contact exposure to light through a negative mesh pattern plate (consisting of line parts having transparency and openings having light-shielding properties). Then, while the laminate was transferred from one station to another, development with water, film hardening, and baking by heating were conducted.

The baked laminate was further carried to the next station, where the laminate was etched by spraying an aqueous ferric chloride solution, an etchant, over the laminate to make openings in the laminate. While transferring the laminate from one station to another, washing with water, resist stripping, cleaning, and drying by heating were conducted, thereby obtaining a metal mesh layer composed of a mesh part 103 having openings in the shape of regular squares, and a 15-mm wide frame part 101 around the mesh part 103 , the width of the lines defining the openings being 10 μm, the distance between the lines (line pitch) being 300 μm, the bias angle (the angle between the lines and the side of the substrate) being 49 degrees, as shown in FIG. 1. The surface roughness Rz of the exposed metal layer was 0.73 to 0.92 μm.

An UV curable urethane acrylate resin was applied to the surface of the mesh part 103 by die coating. The applied amount was 13 g/m².

As the pattern-transfer film 41, a 100-μm thick PET film E5100 (trade name of corona-treated polyethylene terephthalate manufactured by Toyobo Co., Ltd., Japan) was used. The corona-treated surface of the pattern-transfer film 41 (whose surface wettability (in accordance with JIS K-6768) was 44 mN/m/m: measurement results by a mixed liquid for testing wetted tensile force, manufactured by Wako Pure Chemical Industries, Ltd., Japan) was laminated on the applied UV curable acrylate resin, and roller-pressed by a pressure of 1 kPa (10 gf/cm²). Then, by means of a D-valve F600V-10 (trade name of UV irradiation equipment manufactured by Fusion UV systems Japan, Ltd., Japan), ultraviolet light of 365 nm was irradiated on the side of the pattern-transfer film 41, by the accumulated quantity of light of 1.5 J/cm², so that the UV curable resin was cured. Then, the pattern-transfer film was peeled off. The US cured resin on the mesh line part 107 and the frame part 101 of the metal layer was removed together with the pattern-transfer film, with remaining stuck on the pattern-transfer film. On the other hand, the mesh opening part 105 was filled up with the UV cured resin, so that the surface of the UV cured resin was made flat and smooth by transferring the flat smooth surface of the pattern-transfer film. As described above, the electromagnetic wave shielding sheet of an embodiment of the present invention was obtained. In addition, at the mesh line part 107 and the frame part 101, the metal surface was exposed because the UV cured resin was removed.

### EXAMPLE 2

The same manner as in Example 1 was adopted except that a UV curable epoxy acrylate resin was used. The pattern-transfer film was easily peeled off. At the mesh line part 107 and the frame part 101 of the metal layer, the UV cured resin was removed so that the metal surface was exposed.

### EXAMPLE 3

The same manner as in Example 1 was adopted except that a 100-μm thick unprocessed PET film (whose surface wettability was 39 mN/m) was used as the pattern-transfer film. The pattern-transfer film was peeled off with a certain force. At the mesh line part 107 and the frame part 101 of the metal layer, the UV cured resin was removed so that the metal surface was exposed.

### COMPARISON 1

The same manner as in Example 1 was adopted except that a 100-μm thick PET film A4300 (trade name of adhesion-promoting treated PET film, manufactured by Toyobo Co., Ltd., Japan, whose surface wettability is 70 mN/m) was used as the pattern-transfer film. Then, the pattern-transfer film could not be peeled off, and thus an electromagnetic wave shielding sheet was not obtained.

### COMPARISON 2

The same manner as in Example 1 was adopted except that a 100-μm thick releasable PET film (whose surface wettability is 30 mN/m) was used as the pattern-transfer film. When the pattern-transfer film was peeled off, the UV cured resin layer on the entire surface of the metal layer was not removed but left, so that an electromagnetic wave shielding sheet with the metal layer exposed at the frame part was not obtained.

### COMPARISON 3

The same manner as in Example 1 was adopted except that the surface roughness Rz of the electrolytic copper foil, as the metal layer, on the side opposite to the adhesive layer was 0.38 μm. When the pattern-transfer film was peeled off, the metal surface was surely exposed at the frame part, and the ionizing radiation cured resin layer was surely left on the adhesive layer at the mesh opening part. However, some glare was left on the metal layer surface, the image contrast was deteriorated, and reflection of extraneous light and glare was increased, as compared with the example 1.

### COMPARISON 4

The same manner as in Example 1 was adopted except that the surface roughness Rz of the electrolytic copper foil, as the metal layer, on the side opposite to the adhesive layer was 1.69 μm. The image contrast, the reflection of extraneous light and the degree of glare were substantially as good as in Example 1. However, after the pattern-transfer film was peeled off, the ionizing radiation cured resin layer was non-uniformly left, partly on the frame part, so that the position available for grounding was limited.

### (Evaluation)

The electromagnetic wave shielding sheets were evaluated in terms of haze, total luminous transmittance, visibility, and ability to shield electromagnetic waves. The haze was determined in accordance with JIS-K7136, and the total luminous transmittance was measured in accordance with JIS-K7361-1, using a colorimeter HM150 (trade name, manufactured by Murakami Color Research Laboratory, Japan).

The visibility was evaluated in the following manner: the electromagnetic wave shielding sheet was mounted on the front of a PDP, “WOOO” (trade name, manufactured by Hitachi, Ltd., Japan), and a test pattern, a white solid image, and a black solid image were successively displayed on the display screen and were visually observed at a point 50 centimeters distant from the display, at viewing angles of 0 to 80 degrees. Specifically, observations were made on brightness, contrast, the reflection and glaring of extraneous light at the time of black displaying, and the unevenness of the blackening layer at the time of white displaying.

The ability to shield electromagnetic waves was determined by the KEC method (a method of measuring electromagnetic waves, developed by Kansai Electronic Industry Development Center, Japan).

Example 1 and Comparisons 3 and 4 had a haze value of 1.7 and a total luminous transmittance of 83.0, and were excellent also in visibility.

Example 2 had a haze value of 2.4 and a total luminous transmittance of 82.2, and was excellent also in visibility.

Example 3 had a haze value of 1.7 and a total luminous transmittance of 83.1, and was excellent also in visibility.

As for the ability to shield electromagnetic waves, Examples 1 to 3 and Comparisons 3 and 4 attenuated, at rates of 30 to 60 dB, electromagnetic waves having frequencies of 30 MHz to 1000 MHz and were thus confirmed to have satisfactorily excellent electromagnetic wave shielding properties. In Comparisons 1 and 2, the pattern-transfer film could not be peeled off or the UV cured resin layer was not removed, so that an electromagnetic wave shielding sheet with the metal layer exposed at the frame part was not obtained, so that the measurement was not conducted.

1. An electromagnetic wave shielding sheet comprising:
a transparent substrate, and
a metal mesh layer laminated to a surface of the transparent substrate by an adhesive layer,
wherein the metal mesh layer has a mesh part and a frame part around the mash part, the mesh part having a plurality of openings and a plurality of line parts defining the plurality of openings,
a metal surface is exposed at the frame part on a side opposite to the adhesive layer, and
the plurality of openings is filled with a transparent ionizing radiation cured resin.

2. An electromagnetic wave shielding sheet according to claim 1, wherein
surface roughness of the surface of the frame part on the side opposite to the adhesive layer is 0.5 to 1.5 μm as a mean surface roughness value of 10 measurements, obtained in accordance with JIS-B0601 (1994 version).

3. A method for producing an electromagnetic wave shielding sheet according to claim 1, comprising the steps of:
(1) laminating a metal layer to a surface of a transparent substrate by a transparent adhesive layer, thereby obtaining a laminate,
(2) providing a mesh-patterned resist layer on the metal layer face of the laminate, etching the metal layer to remove portions thereof that are not covered with the resist layer, and removing the resist layer, thereby forming in the metal layer a mesh part and a frame part around the mesh part,
(3) applying liquid and transparent ionizing radiation curing resin onto the mesh part and the frame part, laminating a pattern-transfer film onto the ionizing radiation curing resin, and applying ionizing radiation to the ionizing radiation curing resin on a side of the pattern-transfer film, thereby curing the ionizing radiation curing resin, and
(4) removing the pattern-transfer film, and removing the ionizing radiation cured resin at least on the frame part, with leaving the ionizing radiation cured resin in the openings of the mesh part.

4. A method for producing an electromagnetic wave shielding sheet according to claim 3, wherein
the ionizing radiation is ultraviolet light, and
the pattern-transfer film is permeable to ultraviolet light.

5. A method for producing an electromagnetic wave shielding sheet according to claim 3, wherein
an interlayer adhesive force between the adhesive layer and the ionizing radiation cured resin layer, an interlayer adhesive force between the ionizing radiation cured resin layer and the pattern-transfer film, and an interlayer adhesive force between the ionizing radiation cured resin layer and the metal layer are smaller in that order.

6. A method for producing an electromagnetic wave shielding sheet according to claim 2, comprising the steps of:
(1) laminating a metal layer to a surface of a transparent substrate by a transparent adhesive layer, thereby obtaining a laminate,
(2) providing a mesh-patterned resist layer on the metal layer face of the laminate, etching the metal layer to remove portions thereof that are not covered with the resist layer, and removing the resist layer, thereby forming in the metal layer a mesh part and a frame part around the mesh part,
(3) applying liquid and transparent ionizing radiation curing resin onto the mesh part and the frame part, laminating a pattern-transfer film onto the ionizing radiation curing resin, and applying ionizing radiation to the ionizing radiation curing resin on a side of the pattern-transfer film, thereby curing the ionizing radiation curing resin, and
(4) removing the pattern-transfer film, and removing the ionizing radiation cured resin at least on the frame part, with leaving the ionizing radiation cured resin in the openings of the mesh part.

7. A method for producing an electromagnetic wave shielding sheet according to claim 6, wherein
the ionizing radiation is ultraviolet light, and
the pattern-transfer film is permeable to ultraviolet light.

8. A method for producing an electromagnetic wave shielding sheet according to claim 4, wherein
an interlayer adhesive force between the adhesive layer and the ionizing radiation cured resin layer, an interlayer adhesive force between the ionizing radiation cured resin layer and the pattern-transfer film, and an interlayer adhesive force between the ionizing radiation cured resin layer and the metal layer are smaller in that order.

9. A method for producing an electromagnetic wave shielding sheet according to claim 6, wherein
an interlayer adhesive force between the adhesive layer and the ionizing radiation cured resin layer, an interlayer adhesive force between the ionizing radiation cured resin layer and the pattern-transfer film, and an interlayer adhesive force between the ionizing radiation cured resin layer and the metal layer are smaller in that order.

10. A method for producing an electromagnetic wave shielding sheet according to claim 7, wherein
an interlayer adhesive force between the adhesive layer and the ionizing radiation cured resin layer, an interlayer adhesive force between the ionizing radiation cured resin layer and the pattern-transfer film, and an interlayer adhesive force between the ionizing radiation cured resin layer and the metal layer are smaller in that order.
